(19) United States
(12) Patent Application Publication
(10) Pub. No.: US 2026/0252393 A1
(43) Pub. Date: Aug. 27, 2026

(54) HYBRID CONTROL PLANE FOR CLOUD AND EDGE DEPLOYMENTS

(71) Applicant: Microsoft Technology Licensing, LLC, Redmond, WA (US)

(72) Inventors: Faraz H. QADRI, Renton, WA (US); David B. GINER, Redmond, WA (US); Vikas A. NAVALI, Redmond, WA (US); Tanmay WAGHMARE, Sammamish, WA (US)

(73) Assignee: Microsoft Technology Licensing, LLC, Redmond, WA (US)

(21) Appl. No.: 19/065,866

(22) Filed: Feb. 27, 2025

(51) Int. Cl. G06F 9/50

(52) U.S. Cl. CPC G06F 9/5027

(57) ABSTRACT

Systems and methods are provided for implementing a hybrid control plane for cloud and edge deployments. When a local control plane platform receives, from a requesting device, a request to access a first resource from a cloud-based control plane platform, an authentication proxy of a local resource manager of the local control plane platform maps a first identifier (“ID”) to a second ID. The first ID and second ID are associated with the cloud-based control plane platform and the local control plane platform, respectively. The authentication proxy impersonates the requesting user, by generating a query for the first resource using the second ID, and sending the first query to a local resource provider(s) of the local control plane platform. The local control plane platform receives, from the local resource provider(s), a second resource corresponding to the first resource, and sends the second resource to the requesting device.

### BACKGROUND

Users interact with a cloud control plane to manage cloud-provisioned resources. The control plane can be hosted either in a public cloud network or at an edge network (e.g., on-premises) in the case of an air-gapped or disconnected deployment. When managing resources using a public cloud control plane, Internet network connectivity is required. When this connectivity is lost, as part of a planned or unplanned operation, managing of resources is affected. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for a hybrid control plane for cloud and edge deployments. When a local (edge) control plane platform receives, from a requesting device, a request to access a first resource from a cloud-based control plane platform, an authentication proxy of a local resource manager of the local (edge) control plane platform maps a first identifier (“ID”) to a second ID. The first ID is extracted from the request and is associated with both a requesting user and the cloud-based control plane platform, while the second ID is associated with both the requesting user and the local (edge) control plane platform. That is, the first ID is the requesting user's ID in the cloud-based control plane platform, while the second ID is the requesting user's ID in the local (edge) control plane platform. When connection to the cloud-based control plane platform is lost, the local control plane platform performs all operations that would have been performed by the cloud-based control plane platform. The authentication proxy impersonates the requesting user, by generating a query for the first resource based on the second ID, and sending the first query to a local resource provider(s) of the local (edge) control plane platform. The local (edge) control plane platform receives, from the local resource provider(s), a second resource corresponding to the first resource, and sends the second resource to the requesting device.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing a hybrid control plane for cloud and edge deployments.

FIGS. 2A-2D depict various example communication exchanges amongst a requesting device and one or more computing platforms when implementing a hybrid control plane for cloud and edge deployments.

FIGS. 3A-3D depict an example method for implementing a hybrid control plane for cloud and edge deployments.

FIGS. 4A-4D depict another example method for implementing a hybrid control plane for cloud and edge deployments.

FIG. 5 depicts a block diagram illustrating example physical components of a computing device with which aspects of the technology may be practiced.

### DETAILED DESCRIPTION OF CERTAIN EMBODIMENTS

As briefly discussed above, when a network connection to a cloud-based system that provisions cloud-based services and/or resources is lost, provisioning of such services and resources can be affected. Existing solutions to address such a situation involve one or more of backup and restore, migration, or replication and synchronization, each of which is complex and costly to implement. In an example, a government use case includes a requirement for cloud consistency and a need to solve for highly sensitive, critical, and/or secret workloads where data must only be processed locally (e.g., on-premises) while continuing to be accessible even with disconnection from a cloud network. This is often related to either government secrets, like military data or information that is highly protected like Digital Identity for citizens. Existing solutions include a completely disconnected control plane offering for cloud services to manage network edge resources. This control plane is completely local and runs a subset of cloud services in isolation.

The present technology provides for a hybrid control plane for cloud and edge deployments. The hybrid control plane provides continuity when transitioning from one control plane of a computing platform to another, e.g., using a public cloud for managing operations against network edge resources when connected, and then falling back to local on-premises control plane when the need arises, without downtime in managing resources. To enable this functionality, a novel approach of federating management and/or operation requests is implemented between a public cloud control plane and local control plane. The present technology is directed to requesting federation between cloud networks using a proxy connectivity channel or similar communications link. In some examples, a custom globally unique ID (“GUID”) is implemented for discovering cloud types. In examples, resource caching in the cloud network is implemented for processing reads with low latency. In some instances, the system implements ID mapping and impersonation for addressing multiple identity providers. For the government use case, for instance, the present technology extends a control plane from an air-gapped cloud network or local network (“air-gapped network”) to the cloud network, thus allowing a full set of cloud network controls to the air-gapped network resources, operations, and workloads. The control plane extension may be shut down to reinforce air-gapped network isolation in response to certain situations and threats.

Various modifications and additions can be made to the embodiments discussed herein without departing from the scope of the disclosed techniques. For example, while the embodiments described above refer to particular features, the scope of the disclosed techniques also includes embodiments having different combinations of features and embodiments that do not include all of the above-described features.

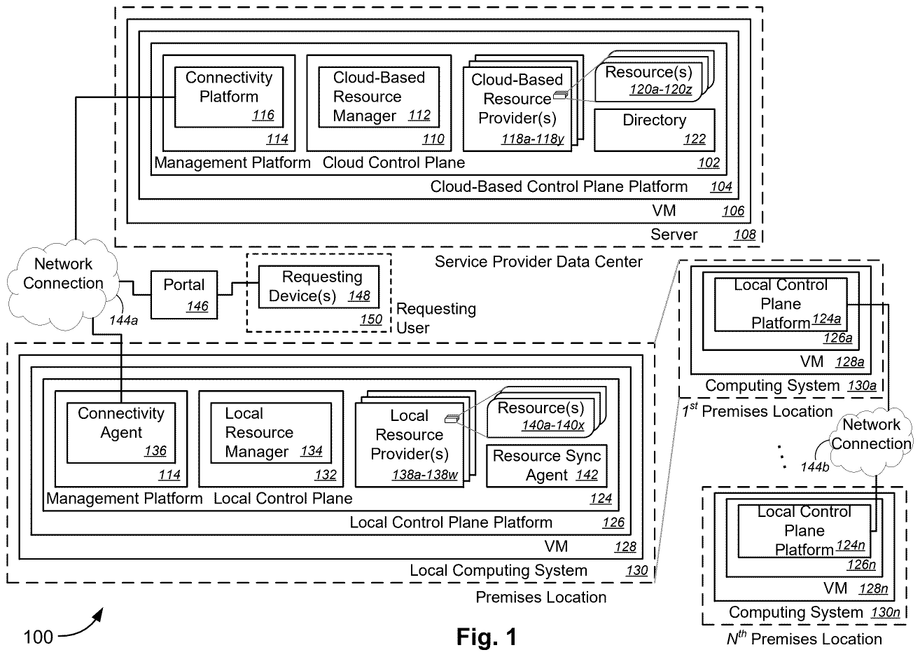

Turning to the embodiments as illustrated by the drawings, FIGS. 1-5 illustrate some of the features of methods, systems, and apparatuses for implementing a hybrid control plane for cloud and edge deployments, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example system 100 for implementing a hybrid control plane for cloud and edge deployments. System 100 includes a cloud-based control plane platform 102 running on a virtual machine (“VM”) 104 that is instantiated within a server 106 at a service provider data center 108. In examples, the cloud-based control plane platform 102 includes a cloud or cloud-based control plane 110 including a cloud-based resource manager 112. The cloud-based control plane platform 102, in some cases, further includes a management platform 114 including a connectivity platform 116. The cloud-based control plane platform 102 further includes one or more cloud-based resource providers 118a-118y (collectively, “cloud-based resource providers 118” or “resource providers 118”), on which one or more resources 120a-120z (collectively, “resources 120”) are stored (or through which the one or more resources 120 may be accessed). The cloud-based control plane platform 102 further includes a directory 122, which maintains a list of the resources 120a-120z that are provided by the cloud-based resource provider(s) 118a-118y. In some examples, the directory 122 is an active directory that actively updates with current information regarding the resources 120a-120z that are provided by the cloud-based resource provider(s) 118a-118y, in some cases, with additional information regarding the resources 120. The cloud-based control plane 110 and/or the cloud-based resource manager 112 is configured to create, delete, update, and/or manage a resource (e.g., resource 120) within the cloud-based control plane platform 102.

In some examples, system 100 further includes a plurality of local (edge) control plane platforms 124a-124n (collectively, “local computing platforms 124”) running on a corresponding plurality of VMs 126a-126n (collectively, “VMs 126”) each of which is instantiated within a corresponding one of a plurality of computing systems 128a-128n (collectively, “computing systems 128”) that is disposed at a corresponding plurality of premises locations 130a-130n (collectively, “premises locations 130”). In examples, each local control plane platform 124 includes a local control plane 132 including a local resource manager 134. In some examples, the management platform 114 extends to each local control plane platform 124, where the management platform 114 at that local control plane platform 124 includes a connectivity agent 136. Each local control plane platform 124 further includes one or more local resource providers 138a-138w (collectively, “local resource providers 138” or “resource providers 138”), on which one or more resources 140a-140x (collectively, “resources 140”) are stored (or through which the one or more resources 140 may be accessed). Each local control plane platform 124 further includes a resource synchronization agent 142. The local control plane 132 and/or the local resource manager 134 is configured to create, delete, update, and/or manage a resource (e.g., resource 140) within the local control plane platform 124. Herein, n, w, x, y, and z are non-negative integer numbers that may be either all the same as each other, all different from each other, or some combination of same and different (e.g., one set of two or more having the same values with the others having different values, a plurality of sets of two or more having the same value with the others having different values).

The management platform 114 provides a centralized, unified system that manages an entire environment together by projecting local or on-premises resources from one or more local control plane platforms 124 into the cloud-based resource manager 112. In some cases, the management platform 114 projects the local or on-premises resources using the connectivity platform 116 of the cloud-based control plane platform 102 to communicate (or exchange connectivity data and/or the resources themselves) with the connectivity agent 136 of each of the one or more local control plane platforms 124, via network connection 144a. The management platform 114 also manages resources (e.g., the VM 104 and/or other VMs instantiated on the server 106, a group or cluster of nodes that runs containerized applications, databases, and/or other resources) as if they are running in the cloud-based control plane platform 102, regardless of where the resources are located (e.g., in one or more of the local control plane platforms 124). In some instances, network connection 144b communicatively couples two or more of the local control plane platforms 124a-124n together. In some examples, the network connection 144a and/or 144b includes connection via one or more networks each of which may include at least one of a distributed computing network, such as the Internet, a private network, a commercial network, or a cloud network, and/or the like.

In examples, the system 100 further includes a portal 146 that communicatively couples a requesting device(s) 148 that is associated with a requesting user 150 to one or more of the cloud-based control plane platform 102 (via connectivity platform 116) and/or to at least one of the local control plane platforms 124 (via connectivity agent 136). The requesting device(s) 148, in some cases, sends a request for access to a resource (e.g., one or more of resources 120a-120z from cloud-based resource provider(s) 118a-118y at the cloud-based control plane platform 102), via the local control plane platform 124. In some cases, the requesting device(s) 148 is located at the same premises location 130 as the local control plane platform 124 to which the requesting device(s) 148 is connected via the portal 146 (which may also be located at the premises location 130). In other cases, the requesting device(s) 148 is located at a location that is separate from either the premises location 130 or the service provider data center 108, and the network connection 144a includes connection to a data network, a cellular communications network, and/or the Internet.

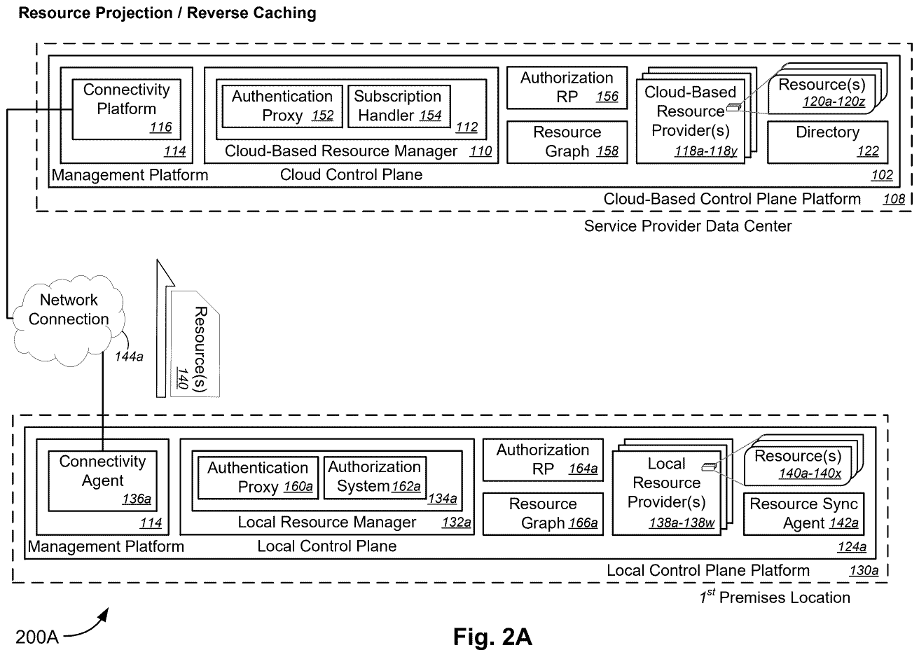

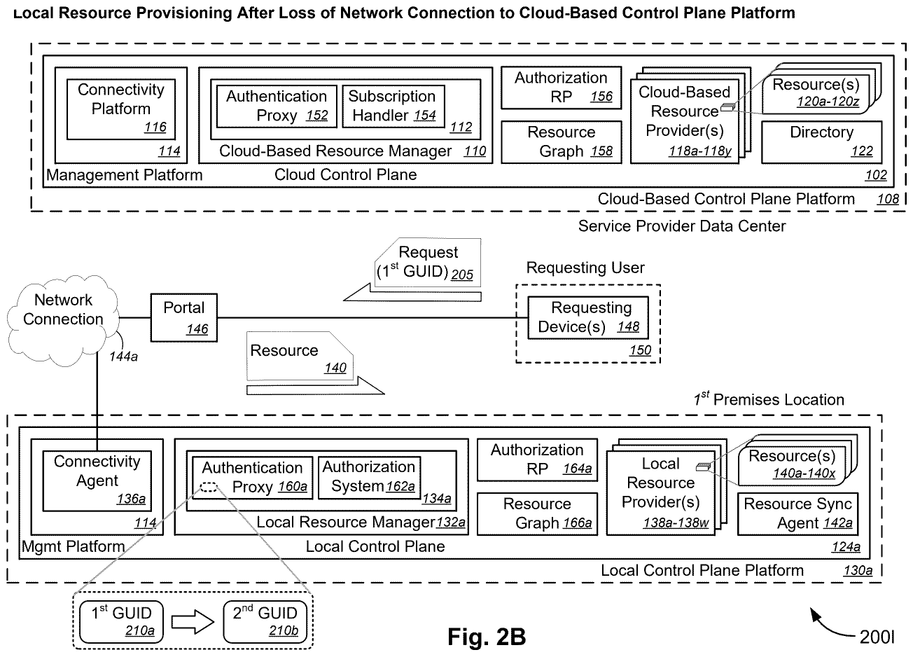

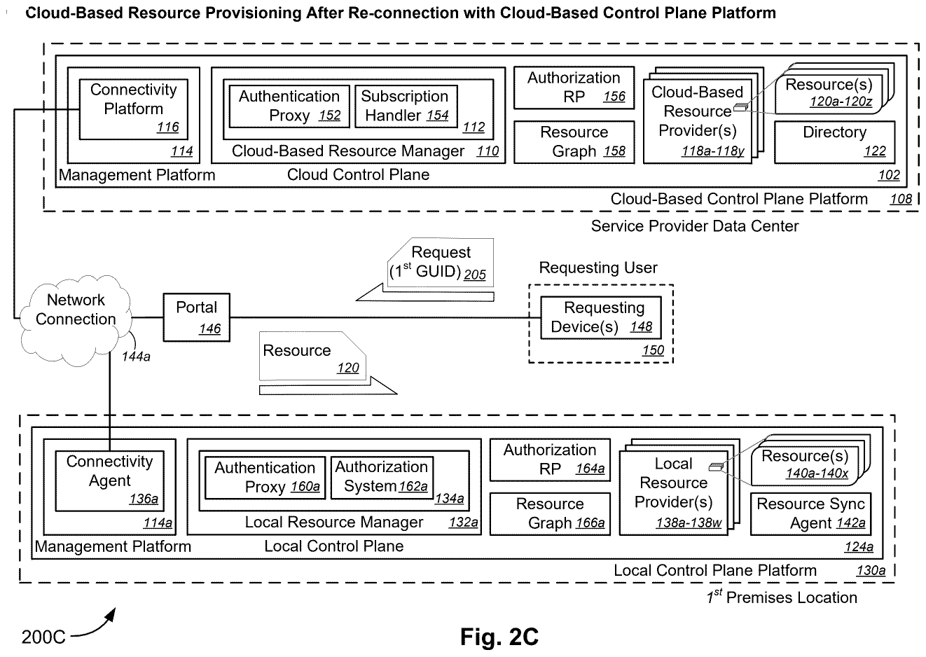

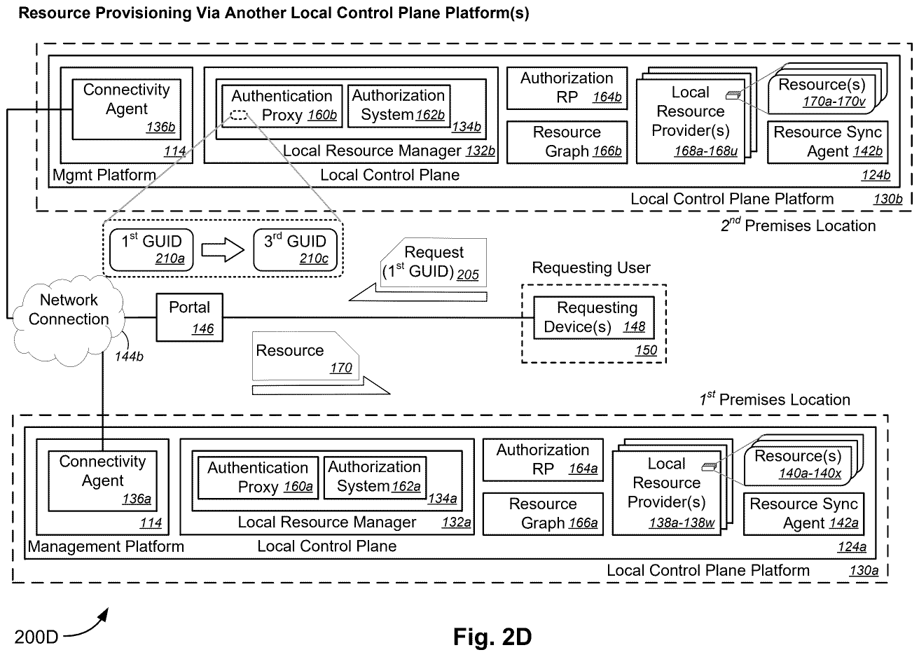

In operation, as described in detail below with respect to FIGS. 2A-4D, in the case that the cloud-based control plane platform 102 is connected to the local control plane platform 124 (e.g., via network connection 144a), the local resource manager 134 and/or the local control plane 132 sends the request to the cloud-based resource manager 112 and/or the cloud-based control plane 110 via the connectivity agent 136 and the connectivity platform 116 over network connection 144a. After receiving the requested resource (e.g., one or more of resources 120a-120z) from the cloud-based resource provider(s) 118a-118y of the cloud-based control plane platform 102, the local resource manager 134 of the local control plane platform 124 sends the requested resource (e.g., the one or more of resources 120a-120z) to the requesting device(s) 148. In the case that connection between the cloud-based control plane platform 102 and the local control plane platform 124 has been lost, the local resource manager 134 and/or the local control plane 132 determines whether the local resource provider(s) 138a-138w contains a resource (e.g., one or more of resources 140a-140x) that corresponds to the requested resource (e.g., the one or more of resources 120a-120z). If so, the local resource manager 134 and/or the local control plane 132 extracts a first ID that corresponds to both the cloud-based control plane platform 102 and the requesting user 150, and maps the first ID to a second ID that corresponds to both the local control plane platform 124 and the requesting user 150. That is, the first ID is the requesting user's ID in the cloud-based control plane platform, while the second ID is the requesting user's ID in the local control plane platform. The local resource manager 134 and/or the local control plane 132 impersonates the requesting user 150 by sending a query to the local resource provider(s) 138a-138w using the second ID (instead of the first ID). After receiving the resource (e.g., the one or more of resources 140a-140x) from the local resource provider(s) 138a-138w, the local resource manager 134 of the local control plane platform 124 sends the requested resource (e.g., the one or more of resources 140a-140x) to the requesting device(s) 148.

In examples, each of the first ID and the second ID is a GUID having an ID format that indicates which computing platform (e.g., cloud-based control plane platform 102 or one of the local control plane platforms 124a-124n) that ID is associated with and that indicates at least one of information indicating a subscription type (e.g., cloud network subscription, air-gapped network subscription, local network subscription, or public network subscription), information indicating a category of that computing platform (e.g., cloud-based or local), information indicating a type of resource providers to which that ID has access within that computing platform (e.g., cloud type or local type), or additional information regarding that computing platform. The GUID can be any suitable length ID with portions indicating the information described above. An example GUID is a 32 hexadecimal character, 128 bit ID, such as follows:

$$xxxxxxxx - xxxx - Sxxx - CTII - xxxxxxxxxxxx \qquad ( Eqn . 1 )$$

where x represents a hexadecimal character, S is a hexadecimal value representing a subscription type, C is a hexadecimal value (in some cases, the 3 least significant bits of this portion of the ID) representing a category of a computing platform that is associated with the subscription, T is a hexadecimal value (or 4 bit character) that carries information regarding the type of resource providers, II are hexadecimal values (or 8 bit characters) that carry information regarding additional information regarding the computing platform.

In some examples, the resource(s) 120a-120z and/or 140a-140x each includes at least one of a compute resource, a storage resource, a VM, a software application, a storage account, a webpage, a website, or a file. In some instances, the file includes one of a text document, a multimedia document, an image file, an audio file, a video file, or a data file. In an example, the request is a hypertext transfer protocol (“HTTP”) request, where the requested resource is one of a first website resource or a first webpage resource that is accessible via the at least one cloud-based resource provider. In some instances, the resource from the local resource provider(s) 138a-138w is one of a second website resource or a second webpage resource that is accessible via the at least one first local resource provider, where the second website resource is a local copy of the first website resource and the second webpage resource is a local copy of the first webpage resource.

In some examples, for use cases requiring handling of secret, sensitive, or confidential data (e.g., government use cases, military use cases, intellectual property use cases, or other sensitive data use cases), a local control plane platform 124 is implemented as an air-gapped network, and the system extends a control plane from the air-gapped network to a cloud network of the cloud-based control plane platform 102. In this manner, a full set of cloud network controls that are available to the cloud-based control plane platform 102 are enabled for control and management of resources, operations, and/or workloads of the air-gapped network. The system further provides options to shut down the control plane extension to reinforce air-gapped network isolation in response to certain situations and threats.

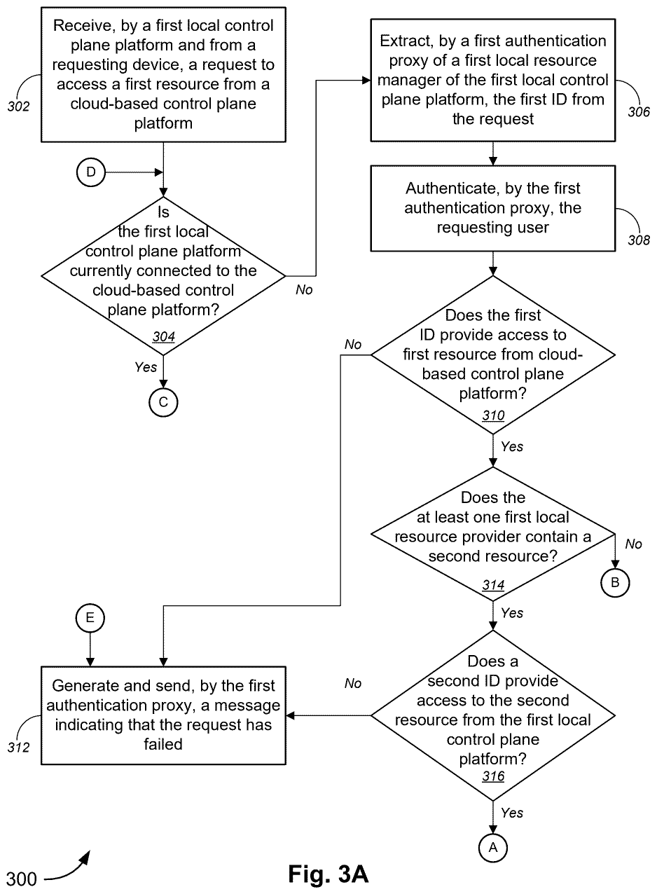

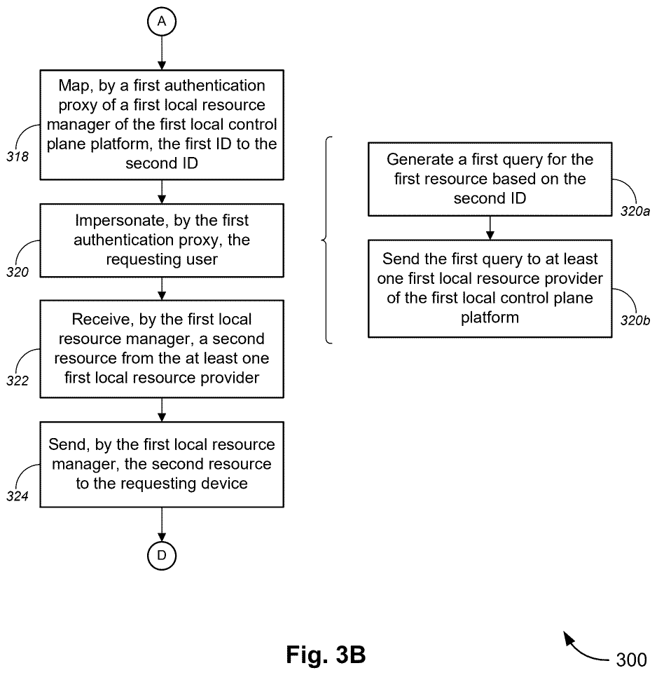

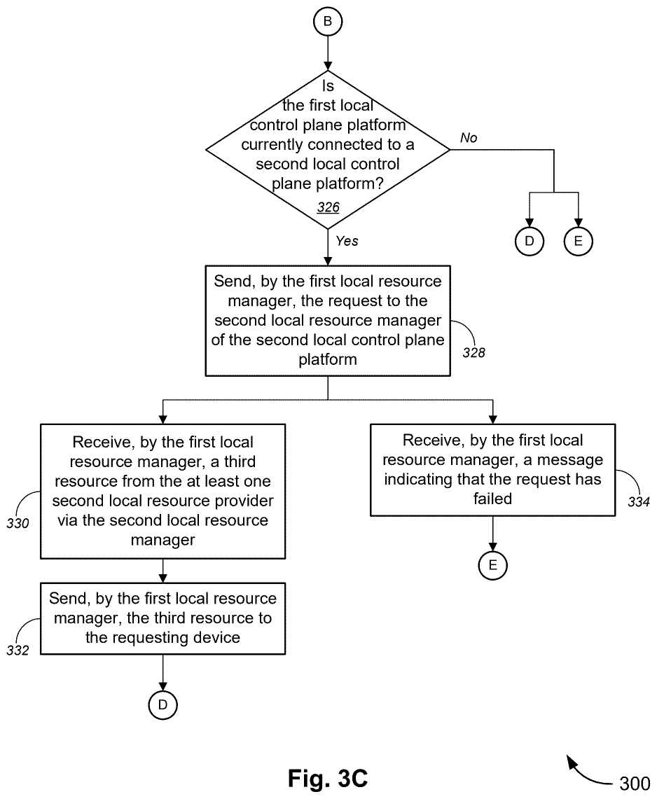

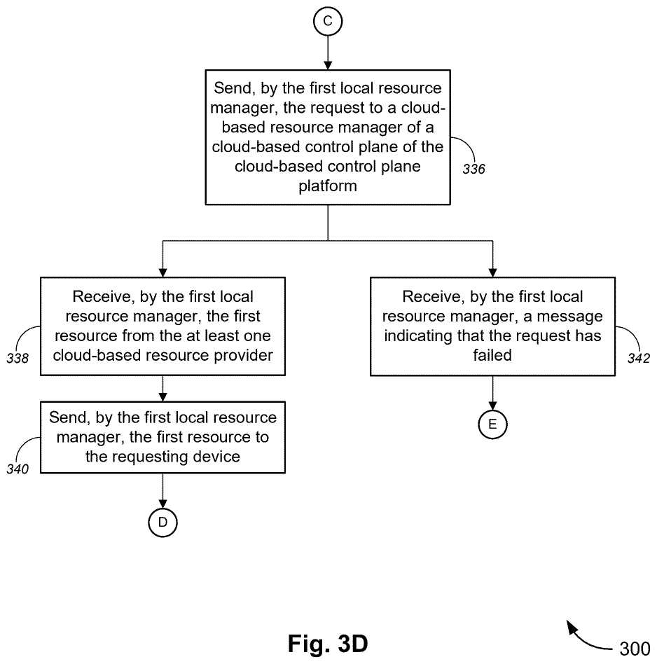

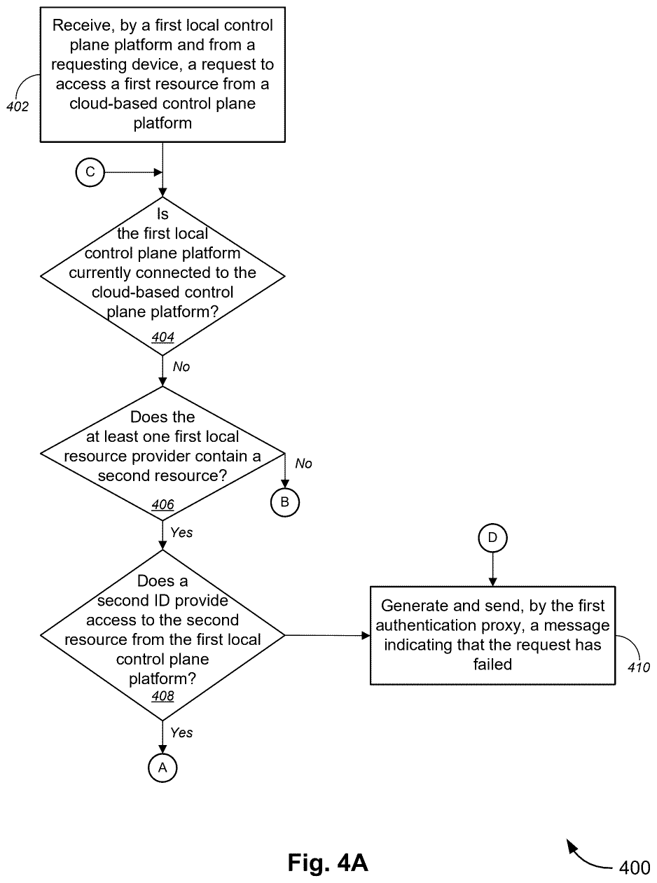

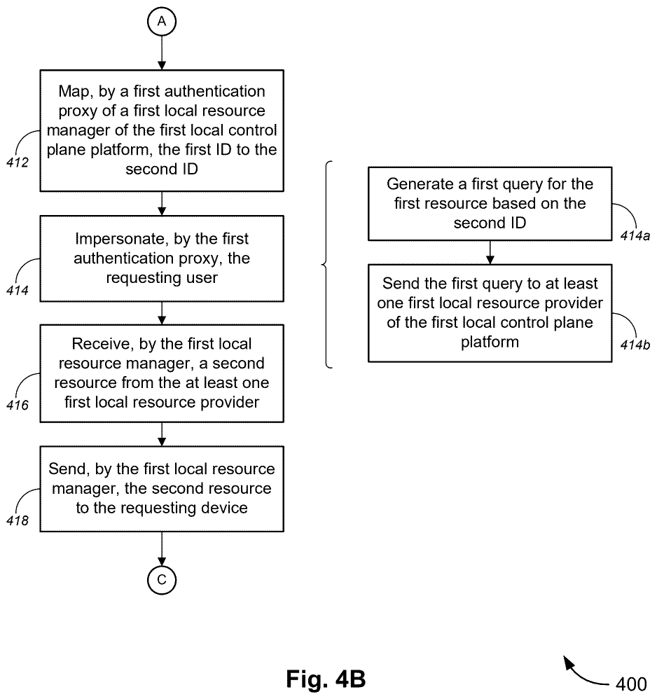

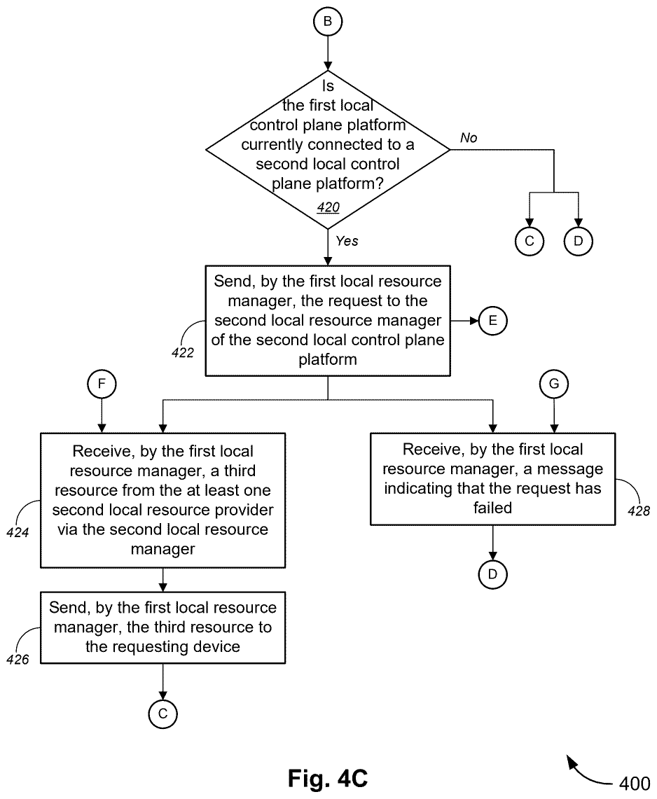

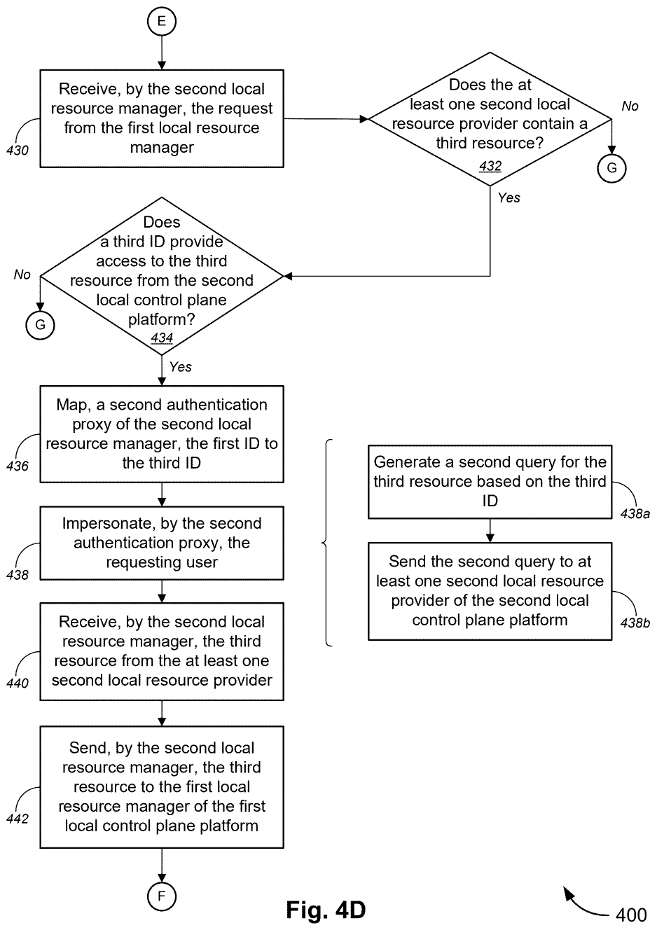

In operation, one or more of the local control plane platforms 124a-124n and/or components of the one or more of the local control plane platforms 124a-124n may perform methods for implementing a hybrid control plane for cloud and edge deployments, as described in detail with respect to FIGS. 2A-4D. For example, example communication exchanges 200A-200D as described below with respect to FIGS. 2A-2D, and methods 300 and 400 as described below with respect to FIGS. 3A-3D and 4A-4D may be applied with respect to the operations of system 100 of FIG. 1.

FIGS. 2A-2D depict various example communication exchanges 200A-200D amongst a requesting device and one or more computing platforms when implementing a hybrid control plane for cloud and edge deployments. In some embodiments, cloud-based control plane platform 102, service provider data center 108, cloud-based control plane 110, cloud-based resource manager 112, management platform 114, connectivity platform 116, cloud-based resource provider(s) 118a-118y, resource(s) 120a-120z, directory 122, local control plane platform 124a or 124b, premises location 130a or 130b, local control plane 132a or 132b, local resource manager 134a or 134b, connectivity agent 136a or 136b, local resource provider(s) 138a-138w or 168a-168u, resource(s) 140a-140x or 170a-170v, resource synchronization agent 142a or 142b, network connection 144a or 144b, portal 146, requesting device(s) 148, and requesting user 150 of FIGS. 2A-2D may be similar, if not identical, to the cloud-based control plane platform 102, service provider data center 108, cloud-based control plane 110, cloud-based resource manager 112, management platform 114, connectivity platform 116, cloud-based resource provider(s) 118a-118y, resource(s) 120a-120z, directory 122, local control plane platforms 124 and 124a-124n, premises locations 130 and 130a-130n, local control plane 132, local resource manager 134, connectivity agent 136, local resource provider(s) 138a-138w, resource(s) 140a-140x, resource synchronization agent 142, network connection 144a or 144b, portal 146, requesting device(s) 148, and requesting user 150, respectively, of system 100 of FIG. 1, and the description of these components of system 100 of FIG. 1 are similarly applicable to the corresponding components of FIGS. 2A-2D.

In some examples, as shown in FIGS. 2A-2C, cloud-based resource manager 112 further includes cloud-based authentication proxy 152 and subscription handler 154, while cloud-based control plane platform 102 further includes cloud-based authorization resource provider (“RP”) 156 and cloud-based resource graph 158. In examples, as shown in FIGS. 2A-2D, first local control plane platform 124a, which is located at first premises location 130a, further includes first local authorization RP 164a and first local resource graph 166a, while first local resource manager 134a of the first local control plane platform 124a further includes first local authentication proxy 160a and first local authorization system 162a. Similarly, as shown in FIG. 2D, second local control plane platform 124b, which is located at second premises location 130b, further includes second local authorization RP 164b and second local resource graph 166b, while second local resource manager 134b of the second local control plane platform 124b further includes second local authentication proxy 160b and second local authorization system 162b.

FIG. 2A depicts resource projection or reverse caching. In examples, when the first local control plane platform 124a is connected to the cloud-based control plane platform 102 (e.g., via the network connection 144a), the resource synchronization agent 142a determines whether the local resource provider(s) 138a-138w contains at least one local resource (e.g., at least one of resources 140a-140x) that is not contained in the cloud-based resource provider(s) 118a-118y. In some cases, the resource synchronization agent 142a compiles a list of resources 140a-140x that are provided by the local resource provider(s) 138a-138w, queries the directory 122 in the cloud-based control plane platform 102 for a list of resources 120a-120z that are provided by the cloud-based resource provider(s) 118a-118y, and compares the list of resources 120a-120z with the list of resources 140a-140x. Based on a determination that the local resource provider(s) 138a-138w contains a first local resource 140 that is not contained in the cloud-based resource provider(s) 118a-118y, the resource synchronization agent projects the first local resource 140 onto the cloud-based resource provider(s) 118a-118y, via the network connection 144a. In some examples, the resource synchronization agent 142a causes the cloud-based resource manager 112 to update the cloud-based resource graph 158 with information regarding the first local resource 140 being projected onto the cloud-based resource provider(s) 118a-118y. In this manner, reverse caching may be achieved in which local resources from the first local control plane platform 124a are cached in the cloud-based control plane platform 102.

FIG. 2B depicts local resource provisioning after loss of network connection to cloud-based control plane platform. After receiving a request 205 from a requesting device(s) 148 associated with a requesting user 150, via portal 146 and network connection 144a, the connectivity agent 136a determines whether the cloud-based control plane platform 102 is currently connected to the first local control plane platform 124a (e.g., via network connection 144a). The request 205 includes a request for a resource 120 from cloud-based control plane platform 102 and a first GUID 210a. Based on a determination that the cloud-based control plane platform 102 is not currently connected to the first local control plane platform 124a, the first authentication proxy 160a of the first local resource manager 134a of the first local control plane 132a of the first local control plane platform 124a extracts the first GUID 210a from the request 205. The first authentication proxy 160a and/or the first local authorization system 162a authenticates the requesting user 150, in some cases, by verifying whether the first GUID 210a provides access to the resource 120 from the cloud-based control plane platform 102. In some instances, authentication and/or verification of the requesting user 150 and/or of the first GUID 210a is performed using the first local authorization RP 164a. Based on a determination that the first GUID 210a is not verified to provide access to the resource 120 from the cloud-based control plane platform 102, the first authentication proxy 160a generates and sends a message to the requesting device(s) 148 indicating that the request 205 has failed. Based on a determination that the first GUID 210a is verified to provide access to the resource 120 from the cloud-based control plane platform, the first local resource manager determines whether at least one first local resource provider 138 among the local resource providers 138a-138w of the first local control plane platform 124a contains a resource corresponding to the resource 120.

Based on a determination that the at least one first local resource provider 138 contains a resource 140 that corresponds to the resource 120, the first authentication proxy 160a and/or the first local authorization system 162a verifies whether a second GUID 210b provides access to the resource 140 from the at least one first local resource provider 138. In some instances, authentication and/or verification of the second GUID 210b is performed using the first local authorization RP 164a. In some cases, the resource 140 corresponds to the resource 120 after resource synchronization (e.g., using the first resource synchronization agent 142a of the first local control plane platform 124a) between the at least one first local resource provider 138 and at least one cloud-based resource provider 118 of the cloud-based control plane platform 102 when the first local control plane platform 124a was previously connected to the cloud-based control plane platform 102 (e.g., via the first network connection 144a). Based on a determination that the second GUID 210b is not verified to provide access to the resource 140 from the at least one first local resource provider 138, the first authentication proxy 160a generates and sends a message to the requesting device(s) 148 indicating that the request 205 has failed. Based on a determination that the second GUID 210b is verified to provide access to the resource 140 from the at least one first local resource provider 138, the first local authentication proxy 160a maps the first GUID 210a to the second GUID 210b (e.g., as depicted in FIG. 2B by the arrow from the first GUID 210a to the second GUID 210b). In some examples, the first authentication proxy 160a impersonates the requesting user, by generating a first query for the resource 140 based on the second GUID 210b, and sending the first query to at least one first local resource provider 138, in some cases, using the first local resource graph 166a to generate and send the first query. After receiving the resource 140 from the at least one first local resource provider 138, the first local resource manager 134a sends the resource 140 to the requesting device(s) 148, in some cases, via one or more of the portal 146, the network connection 144a, and/or the connectivity agent 136a.

FIG. 2C depicts cloud-based resource provisioning after re-connection of network connection to cloud-based control plane platform. After receiving the request 205, and after reconnecting with the cloud-based control plane platform 102 (e.g., via the first network connection 144a) or after determining that the first local control plane platform 124a is currently connected or has re-established connection to the cloud-based control plane platform 102, the first local resource manager 134a sends the request 205 to the cloud-based resource manager 112 of the cloud-based control plane platform 102. In some cases, the request 205 is sent via the network connection 144a, the connectivity agent 136a of the first local control plane platform 124a, and the connectivity platform 116 of the cloud-based control plane platform 102.

At the cloud-based control plane platform 102, the cloud-based authentication proxy 152 of the cloud-based resource manager 112 of the cloud-based control plane 110 extracts the first GUID 210a from the request 205. The cloud-based authentication proxy 152 and/or the subscription handler 154 authenticates the requesting user 150, in some cases, by verifying whether the first GUID 210a provides access to the resource 120 from the cloud-based control plane platform 102. In some instances, authentication and/or verification of the requesting user 150 and/or of the first GUID 210a is performed using the cloud-based authorization RP 156. Based on a determination that the first GUID 210a is not verified to provide access to the resource 120 from the cloud-based control plane platform 102, the cloud-based authentication proxy 152 generates and sends a message to the requesting device(s) 148 indicating that the request 205 has failed. In some cases, the message is sent directly from the cloud-based resource manager 112 to the requesting device(s) 148, via portal 146 and network connection 144a, without routing through the first local control plane platform 124a. In other cases, the message is first routed through the first local resource manager 134a, which forwards the message to the requesting device(s) 148, via portal 146 and network connection 144a. In still other cases, the cloud-based resource manager 112 sends information to the first local resource manager 134a that the first GUID 210a is not verified to provide access to the resource 120 from the cloud-based control plane platform 102, and the first local resource manager 134a generates and sends the message to the requesting device(s) 148 indicating that the request 205 has failed.

Based on a determination that the first GUID 210a is verified to provide access to the resource 120 from the cloud-based control plane platform, the cloud-based resource manager 112 and/or the cloud-based authentication proxy 152 queries the directory 122 for the at least one cloud-based resource provider 118 containing the resource 120, in some cases, using the resource graph 158. After accessing and receiving the resource 120 from the at least one cloud-based resource provider 118, the cloud-based resource manager 112 sends the resource 120 to the requesting device(s) 148, in some cases, via one or more of the portal 146 and the network connection 144a. In some cases, the resource 120 is sent directly from the cloud-based resource manager 112 to the requesting device(s) 148, via portal 146 and network connection 144a, without routing through the first local control plane platform 124a. In other cases, the resource 120 is first routed through the first local resource manager 134a, which forwards the resource 120 to the requesting device(s) 148, via portal 146 and network connection 144a.

FIG. 2D depicts resource provisioning via another local control plane platform(s) among the local control plane platforms 124a-124n of FIG. 1. After receiving the request 205, after determining that the first local control plane platform 124a is not currently connected to the cloud-based control plane platform 102 (as described above with respect to FIG. 2B), and after determining that the local resource providers 138a-138w do not contain a resource that corresponds to the requested resource 120, the first connectivity agent 136a determines whether the first local control plane platform 124a is currently connected to any other local control plane platforms 124a-124n. Based on a determination that the first local control plane platform 124a is currently connected to at least one other local control plane platform 124b-124n (e.g., via network connection 144b), the resource synchronization agent 142a communicates with the corresponding resource synchronization agent 142 of each of the at least one other local control plane platform 124b-124n to determine whether any of the at least one other local control plane platform 124b-124n has a corresponding at least one second local resource provider 168 that contains a resource corresponding to the resource 120.

In an example, after determining that the first local control plane platform 124a is currently connected to a second local control plane platform 124b (e.g., via network connection 144b) that has at least one second local resource provider 168 that contains a resource 170 that corresponds to the resource 120, the first local resource manager 134a forwards the request 205 to a second local resource manager 134b of the second local control plane platform 124b, in some cases, via network connection 144b, the connectivity agent 136a of the first local control plane platform 124a, and/or the connectivity agent 136b of the second local control plane platform 124b. After receiving the request 205, the second local authentication proxy 160b and/or the second local authorization system 162b verifies whether a third GUID 210c provides access to the resource 170 from the at least one second local resource provider 168. In some instances, authentication and/or verification of the third GUID 210c is performed using the second local authorization RP 164b. In some cases, the resource 170 corresponds to the resource 120 after resource synchronization (e.g., using the second resource synchronization agent 142b of the second local control plane platform 124b) between the at least one second local resource provider 168 and at least one cloud-based resource provider 118 of the cloud-based control plane platform 102 when the second local control plane platform 124b was previously connected to the cloud-based control plane platform 102 (e.g., via a network connection similar to the first network connection 144a).

Based on a determination that the third GUID 210c is not verified to provide access to the resource 170 from the at least one second local resource provider 168, the second local authentication proxy 160b generates and sends a message to the requesting device(s) 148 indicating that the request 205 has failed. In some cases, the message is sent directly from the second local resource manager 134b to the requesting device(s) 148, via portal 146 and network connection 144b, without routing through the first local control plane platform 124a. In other cases, the message is first routed through the first local resource manager 134a, which forwards the message to the requesting device(s) 148, via portal 146 and network connection 144b. In still other cases, the second local resource manager 134b sends information to the first local resource manager 134a that the third GUID 210c is not verified to provide access to the resource 170 from the at least one second local resource provider 168, and the first local resource manager 134a generates and sends the message to the requesting device(s) 148 indicating that the request 205 has failed.

Based on a determination that the third GUID 210c is verified to provide access to the resource 170 from the at least one second local resource provider 168, the second local authentication proxy 160b maps the first GUID 210a to the third GUID 210c (e.g., as depicted in FIG. 2D by the arrow from the first GUID 210a to the third GUID 210c). In some examples, the second local authentication proxy 160b impersonates the requesting user, by generating a second query for the resource 170 based on the third GUID 210c, and sending the second query to at least one second local resource provider 168, in some cases, using the second local resource graph 166b to generate and send the second query. After receiving the resource 170 from the at least one second local resource provider 168, the second local resource manager 134b sends the resource 170 to the requesting device(s) 148, in some cases, via one or more of the portal 146, the network connection 144b, and/or the connectivity agent 136b. In some cases, the resource 170 is sent directly from the second local resource manager 134b to the requesting device(s) 148, via portal 146 and network connection 144b, without routing through the first local control plane platform 124a. In other cases, the resource 170 is first routed through the first local resource manager 134a, which forwards the resource 170 to the requesting device(s) 148, via portal 146 and network connection 144b.

Although not shown in FIGS. 2A-2D, resource 120, 140, and/or 170 can be projected onto a resource provider of either the cloud-based control plane platform 102 and/or any of one or more local control plane platforms 124 in a manner similar to the process as described above with respect to FIG. 2A. In some examples, resource provisioning can involve interactions or provisioning via two or more local control plane platforms 124 (whether the cloud-based control plane platform 102 is involved or is off-line/disconnected) in a manner similar to the process as described above with respect to FIG. 2D. In some cases, one local control plane platform 124 can query and/or forward the request to another local control plane platform 124, which in turn can query and/or forward the request to yet another local control plane platform 124 (e.g., in a chain), until a resource corresponding to the requested resource is found, queried, and accessed, at which point, the resource is sent directly or indirectly along the chain to the requesting device(s) 148.

FIGS. 3A-3D depict an example method 300 for implementing a hybrid control plane for cloud and edge deployments. With reference to FIGS. 3A-3D, the operations of example method 300 may be performed by a local control plane platform (e.g., one of local control plane platforms 124 and 124a-124n of FIGS. 1 and 2A-2C) or components of the local control plane platform (including a local resource manager 134 of one of local control plane platforms 124 and 124a-124n of FIGS. 1 and 2A-2C, or authentication proxy 160a of the local resource manager 134 of FIGS. 2A-2C). Method 300 of FIG. 3A continues onto FIG. 3B following the circular marker denoted, “A,” and returns to FIG. 3A following the circular marker denoted, “D.” Method 300 of FIG. 3A continues onto FIG. 3C following the circular marker denoted, “B,” and returns to FIG. 3A following the circular marker denoted, “D” or “E.” Method 300 of FIG. 3A continues onto FIG. 3D following the circular marker denoted, “C,” and returns to FIG. 3A following the circular marker denoted, “D” or “E.”

In the example method 300 of FIG. 3A, at operation 302, a first local control plane platform receives, from a requesting device (e.g., requesting device(s) 148 of FIGS. 1, 2B, and 2C), a request to access a first resource from a cloud-based control plane platform (e.g., cloud-based control plane platform 102 of FIGS. 1 and 2A-2C). In some cases, the request includes a first ID that is associated with both a requesting user (e.g., requesting user 150 of FIGS. 1 and 2B-2D) and the cloud-based control plane platform. At operation 304, a first connectivity agent (e.g., a connectivity agent 136 of one of local control plane platforms 124 and 124a-124n of FIGS. 1 and 2A-2C) of the first local control plane platform determines whether the first local control plane platform is currently connected to the cloud-based control plane platform, e.g., via a first network connection (e.g., network connection 144a of FIGS. 1 and 2A-2C). Based on a determination that the first local control plane platform is currently connected to the cloud-based control plane platform (e.g., via the first network connection), method 300 continues onto the process at operation 336 of FIG. 3D, following the circular marker denoted, “C.” Based on a determination that the first local control plane platform is not currently connected (or has lost the first network connection) to the cloud-based control plane platform, method 300 continues onto the process at operation 306.

At operation 306, a first authentication proxy of a first local resource manager of the first local control plane platform extracts the first ID from the request. At operation 308, the first authentication proxy authenticates the requesting user, in some cases, by verifying whether the first ID provides access to the first resource from the cloud-based control plane platform (at operation 310). Based on a determination that the first ID is not verified to provide access to the first resource from the cloud-based control plane platform, the first authentication proxy generates and sends a message indicating that the request has failed (at operation 312). Based on a determination that the first ID is verified to provide access to the first resource from the cloud-based control plane platform, the first local resource manager determines whether at least one first local resource provider (e.g., at least one of local resource providers 138a-138w of FIGS. 1 and 2A-2C) of the first local control plane platform contains a second resource corresponding to the first resource (at operation 314). In some cases, the second resource corresponds to the first resource after resource synchronization (e.g., using a first resource synchronization agent 142 or 142a of the first local control plane platform of FIGS. 1 and 2A-2C) between the at least one first local resource provider and at least one cloud-based resource provider of the cloud-based computing system when the first local control plane platform was previously connected to the cloud-based control plane platform via the first network connection. Based on a determination that the at least one first local resource provider does not contain the second resource, method 300 continues onto the process at operation 326 in FIG. 3C, following the circular marker denoted, “B.” Based on a determination that the at least one first local resource provider contains the second resource, method 300 continues onto the process at operation 316.

At operation 316, the first authentication proxy verifies whether a second ID provides access to the second resource from the at least one first local resource provider of the first local control plane platform, the second ID being associated with both the requesting user and the first local control plane platform. Based on a determination that the second ID is verified to provide access to the second resource from the at least one first local resource provider, method 300 continues onto the process at operation 318 in FIG. 3B, following the circular marker denoted, “A.” Based on a determination that the second ID is not verified to provide access to the second resource from the at least one first local resource provider, method 300 continues onto the process at operation 312, at which the first authentication proxy generates and sends a message indicating that the request has failed.

At operation 318 in FIG. 3B (following the circular marker denoted, “A,” in FIG. 3A), method 300 may include the first authentication proxy mapping the first ID to the second ID. At operation 320, the first authentication proxy impersonates the requesting user, by generating a first query for the first resource based on the second ID (at operation 320a); and sending the first query to at least one first local resource provider of the first local control plane platform (at operation 320b), in some cases, using a first local resource graph. At operation 322, the first local resource manager receives the second resource from the at least one first local resource provider. At operation 324, the first local resource manager sends the second resource to the requesting device. Method 300 returns to the process at operation 304 in FIG. 3A, following the circular marker denoted, “D.”

At operation 326 in FIG. 3C (following the circular marker denoted, “B,” in FIG. 3A), method 300 may include the first connectivity agent determining whether the first local control plane platform is currently connected to a second local control plane platform (e.g., another one of local control plane platforms 124 and 124a-124n of FIGS. 1 and 2A-2C or local control plane platform 124b of FIG. 2D)), e.g., via a second network connection (e.g., network connection 144b of FIGS. 1 and 2D). Based on a determination that the first local control plane platform is currently connected to the second local control plane platform (e.g., via the second network connection), method 300 continues onto the process at operation 328. Based on a determination that the first local control plane platform is not currently connected to the second local control plane platform, method 300 either returns to the process at operation 304 of FIG. 3A, following the circular marker denoted, “D,” or returns to the process at operation 312 of FIG. 3A, following the circular marker denoted, “E.” In examples, the cloud-based control plane platform is implemented within a server (e.g., server 106 of FIG. 1) in a service provider data center (e.g., service provider data center 108 of FIGS. 1 and 2A-2D) that is associated with a service provider. In some cases, the first local control plane platform is implemented within a first local computing system at a first premises location (e.g., one of local computing systems 128 and 128a-128n at corresponding premises locations 130 and 130a-130n of FIG. 1). In some examples, the first local computing system is sent to the first premises location by the service provider. In some instances, the first local control plane platform is implemented in a VM (e.g., a corresponding one of VMs 126 and 126a-126n of FIG. 1) that is instantiated in the first local computing system. Similarly, the second local control plane platform is implemented in another VM (e.g., another corresponding one of VMs 126 and 126a-126n of FIG. 1) that is instantiated in the second local computing system.

At operation 328, the first local resource manager sends the request to the second local resource manager of the second local control plane platform. Method 300 either continues onto the process at operation 330 or continues onto the process at operation 334. At operation 330, the first local resource manager receives a third resource from the at least one second local resource provider via the second local resource manager, the third resource corresponding to the first resource. At operation 332, the first local resource manager sends the third resource to the requesting device. Method 300 returns to the process at operation 304 of FIG. 3A, following the circular marker denoted, “D.” At operation 334, the first local resource manager receives a message indicating that the request has failed. Method 300 returns to the process at operation 312 of FIG. 3A, following the circular marker denoted, “E.”

At operation 336 in FIG. 3D (following the circular marker denoted, “C,” in FIG. 3A), based on a determination that the first local control plane platform is currently connected or has re-established connection to the cloud-based control plane platform via the first network connection, the first local resource manager sends the request to a cloud-based resource manager (e.g., cloud-based resource manager 112 of FIGS. 1 and 2A-2C) of the cloud-based control plane platform. Method 300 either continues onto the process at operation 338 or continues onto the process at operation 342. At operation 338, the first local resource manager receives the first resource from the at least one cloud-based resource provider. At operation 340, the first local resource manager sends the first resource to the requesting device. Method 300 returns to the process at operation 304 of FIG. 3A, following the circular marker denoted, “D.” At operation 342, the first local resource manager receives a message indicating that the request has failed. Method 300 returns to the process at operation 312 of FIG. 3A, following the circular marker denoted, “E.”

FIGS. 4A-4D depict another example method 400 for implementing a hybrid control plane for cloud and edge deployments. Referring to FIGS. 4A-4D, the operations of example method 400 may be performed by one or more local control plane platforms (e.g., one or more local control plane platforms among local control plane platforms 124 and 124a-124n of FIGS. 1 and 2A-2D) or components of each local control plane platform (including a local resource manager 134 of the one or more local control plane platforms among local control plane platforms 124 and 124a-124n of FIGS. 1 and 2A-2D, or authentication proxy 160a of the local resource manager 134 of FIGS. 2A-2D). Method 400 of FIG. 4A continues onto FIG. 4B following the circular marker denoted, “A,” and returns to FIG. 4A following the circular marker denoted, “C.” Method 400 of FIG. 4A continues onto FIG. 4C following the circular marker denoted, “B,” and returns to FIG. 4A following the circular marker denoted, “C” or “D.” Method 400 of FIG. 4C continues onto FIG. 4D following the circular marker denoted, “E,” and returns to FIG. 4C following the circular marker denoted, “F” or “G.”

In the example method 400 of FIG. 4A, at operation 402, a first local control plane platform receives, from a requesting device (e.g., requesting device(s) 148 of FIGS. 1 and 2B-2D), a request to access a first resource from a cloud-based control plane platform (e.g., cloud-based control plane platform 102 of FIGS. 1 and 2A-2C). In some cases, the request includes a first ID that is associated with both a requesting user (e.g., requesting user 150 of FIGS. 1 and 2B-2D) and the cloud-based control plane platform. At operation 404, a first connectivity agent (e.g., a connectivity agent 136 of one of local control plane platforms 124 and 124a-124n of FIGS. 1 and 2A-2C) of the first local control plane platform determines whether the first local control plane platform is currently connected to the cloud-based control plane platform, e.g., via a first network connection (e.g., network connection 144a of FIGS. 1 and 2A-2C). Based on a determination that the first local control plane platform is not currently connected (or has lost the first network connection) to the cloud-based control plane platform, method 400 continues onto the process at operation 406.

At operation 406, the first local resource manager determines whether at least one first local resource provider (e.g., at least one of local resource providers 138a-138w of FIGS. 1 and 2A-2C) of the first local control plane platform contains a second resource corresponding to the first resource (at operation 414). In some cases, the second resource corresponds to the first resource after resource synchronization (e.g., using a first resource synchronization agent 142 or 142a of the first local control plane platform of FIGS. 1 and 2A-2C) between the at least one first local resource provider and at least one cloud-based resource provider of the cloud-based computing system when the first local control plane platform was previously connected to the cloud-based control plane platform via the first network connection. Based on a determination that the at least one first local resource provider does not contain the second resource, method 400 continues onto the process at operation 420 in FIG. 4C, following the circular marker denoted, “B.” Based on a determination that the at least one first local resource provider contains the second resource, method 400 continues onto the process at operation 408.

At operation 408, the first authentication proxy verifies whether a second ID provides access to the second resource from the at least one first local resource provider of the first local control plane platform, the second ID being associated with both the requesting user and the first local control plane platform. Based on a determination that the second ID is verified to provide access to the second resource from the at least one first local resource provider, method 400 continues onto the process at operation 412 in FIG. 4B, following the circular marker denoted, “A.” Based on a determination that the second ID is not verified to provide access to the second resource from the at least one first local resource provider, method 400 continues onto the process at operation 410, at which the first authentication proxy generates and sends a message indicating that the request has failed.

At operation 412 in FIG. 4B (following the circular marker denoted, “A,” in FIG. 4A), method 400 may include the first authentication proxy mapping the first ID to the second ID. At operation 414, the first authentication proxy impersonates the requesting user, by: generating a first query for the first resource based on the second ID (at operation 414a); and sending the first query to at least one first local resource provider of the first local control plane platform (at operation 414b), in some cases, using a first local resource graph. At operation 416, the first local resource manager receives the second resource from the at least one first local resource provider. At operation 418, the first local resource manager sends the second resource to the requesting device. Method 400 returns to the process at operation 404 in FIG. 4A, following the circular marker denoted, “C.”

At operation 420 in FIG. 4C (following the circular marker denoted, “B,” in FIG. 4A), method 400 may include the first connectivity agent determining whether the first local control plane platform is currently connected to a second local control plane platform (e.g., another one of local control plane platforms 124 and 124a-124n of FIGS. 1 and 2A-2C or local control plane platform 124b of FIG. 2D)), e.g., via a second network connection (e.g., network connection 144b of FIGS. 1 and 2D). Based on a determination that the first local control plane platform is currently connected to the second local control plane platform (e.g., via the second network connection), method 400 continues onto the process at operation 422. Based on a determination that the first local control plane platform is not currently connected to the second local control plane platform, method 400 either returns to the process at operation 404 of FIG. 4A, following the circular marker denoted, “C,” or returns to the process at operation 410 of FIG. 4A, following the circular marker denoted, “D.” In examples, the cloud-based control plane platform is implemented within a server (e.g., server 106 of FIG. 1) in a service provider data center (e.g., service provider data center 108 of FIGS. 1 and 2A-2D) that is associated with a service provider. In some cases, the first local control plane platform is implemented within a first local computing system at a first premises location (e.g., one of local computing systems 128 and 128a-128n at corresponding premises locations 130 and 130a-130n of FIG. 1). In some examples, the first local computing system is sent to the first premises location by the service provider. In some instances, the first local control plane platform is implemented in a VM (e.g., a corresponding one of VMs 126 and 126a-126n of FIG. 1) that is instantiated in the first local computing system. Similarly, the second local control plane platform is implemented in another VM (e.g., another corresponding one of VMs 126 and 126a-126n of FIG. 1) that is instantiated in the second local computing system.

At operation 422, the first local resource manager sends the request to the second local resource manager of the second local control plane platform. Method 400 either continues onto the process at operation 424 or continues onto the process at operation 428. At operation 424, the first local resource manager receives a third resource from the at least one second local resource provider via the second local resource manager, the third resource corresponding to the first resource. At operation 426, the first local resource manager sends the third resource to the requesting device. Method 400 returns to the process at operation 404 of FIG. 4A, following the circular marker denoted, “C.” At operation 428, the first local resource manager receives a message indicating that the request has failed. Method 400 returns to the process at operation 410 of FIG. 4A, following the circular marker denoted, “D.” In response to the first local resource manager sending the request to the second local resource manager (at operation 422), method 400 continues onto the process at operation 430 of FIG. 4D, following the circular marker denoted, “E.”

At operation 430 in FIG. 4D (following the circular marker denoted, “E,” in FIG. 4C), the second local resource manager receives the request from the first local resource manager. At operation 432, the second local resource manager determines whether the at least one second local resource provider contains the third resource corresponding to the first resource. Based on a determination that the at least one second local resource provider does not contains the third resource, method 400 returns to the process at 428 in FIG. 4C, following the circular marker denoted, “G.” Based on a determination that the at least one second local resource provider contains the third resource, method 400 continues onto the process at operation 434. At operation 434, a second authentication proxy of the second local resource manager verifies whether a third ID provides access to the third resource from the at least one second local resource provider of the second local control plane platform, the third ID being associated with both the requesting user and the second local control plane platform. Based on a determination that the third ID is verified to provide access to the third resource from the at least one second local resource provider, method 400 continues onto the process at operation 436. Based on a determination that the third ID is not verified to provide access to the third resource from the at least one second local resource provider, method 400 returns to the process at 428 in FIG. 4C, following the circular marker denoted, “G.”

At operation 436, the second authentication proxy mapping the first ID to the third ID. At operation 438, the second authentication proxy impersonates the requesting user, by: generating a second query for the third resource based on the third ID (at operation 438a); and sending the second query to at least one second local resource provider of the second local control plane platform (at operation 438b), in some cases, using a second local resource graph. At operation 440, the second local resource manager receives the third resource from the at least one second local resource provider. At operation 442, the second local resource manager sends the third resource to the first local resource manager of the first local control plane platform. Method 400 returns to the process at operation 424 in FIG. 4C, following the circular marker denoted, “F.”

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200A-200D of FIGS. 1 and 2A-2D, respectively (or components thereof), such methods may also be implemented using any suitable hardware (or software) implementation. Similarly, while each of the systems, examples, or embodiments 100 and 200A-200D of FIGS. 1 and 2A-2D, respectively (or components thereof), can operate according to the methods 300, 400 (e.g., by executing instructions embodied on a computer readable medium), the systems, examples, or embodiments 100 and 200A-200D of FIGS. 1 and 2A-2D can each also operate according to other modes of operation and/or perform other suitable procedures.

As should be appreciated from the foregoing, the present technology provides multiple technical benefits and solutions to technical problems. For instance, provisioning cloud-based services or resources generally raises multiple technical problems. For example, one technical problem includes provisioning of such services and resources being affected when a network connection to a cloud-based system that provisions cloud-based services and/or resources is lost. Existing solutions to address such a situation involve one or more of backup and restore, migration, or replication and synchronization, which are complex and costly to implement. The present technology provides for a hybrid control plane for cloud and edge deployments. The present technology is directed to requesting federation between cloud networks using a proxy connectivity channel or similar communications link. In some examples, a custom GUID is implemented for discovering cloud types. In examples, resource caching in the cloud network is implemented for processing reads with low latency. In some instances, the system implements ID mapping and impersonation for addressing multiple identity providers. In this manner, enhanced reliability in provisioning of services and/or resources is achieved. In some cases, where the resources are provisioned from edge network computing platforms and/or from local control plane platforms, improved latency is also achieved. Air-gapping for handling of secret, sensitive, or confidential data (e.g., when shutting down control plane extension) enables improved system and data security.

In an aspect, the technology relates to a system, including a first local control plane platform, which includes a first local resource manager of a first local control plane; a first connectivity agent of a management platform; at least one first local resource provider; and a first resource synchronization agent. The first local control plane platform executes computer executable instructions that cause the first local control plane platform to perform first operations. The first operations include receiving, from a requesting device, a request to access a first resource stored in a cloud-based control plane platform. The request include a first ID that is associated with both a requesting user and the cloud-based control plane platform. The first operations further include determining, using the first connectivity agent, whether the first local control plane platform is currently connected to the cloud-based control plane platform. The first operations further include, based on a determination that the first local control plane platform has lost network connection to the cloud-based control plane platform, mapping, by a first authentication proxy of the first local resource manager, the first ID to a second ID that is associated with both the requesting user and the first local control plane platform; impersonating, by the first authentication proxy, the requesting user, by: generating a first query for the first resource based on the second ID; and sending the first query to the at least one first local resource provider. The first operations further include, and further based on a determination that the first local control plane platform has lost network connection to the cloud-based control plane platform, receiving, by the first local resource manager, a second resource from the at least one first local resource provider; and sending, by the first local resource manager, the second resource to the requesting device. The second resource corresponds to the first resource after resource synchronization, using the first resource synchronization agent, between the at least one first local resource provider and at least one cloud-based resource provider of the cloud-based computing system when the first local control plane platform was previously connected to the cloud-based control plane platform via the network connection.

In some examples, the cloud-based control plane platform is implemented within a server in a service provider data center that is associated with a service provider. In some cases, the first local control plane platform is implemented within a first local computing system at a first premises location. In some instances, the first local computing system is sent to the first premises location by the service provider, and wherein the first local control plane platform is implemented in a VM that is instantiated in the first local computing system.

In examples, the request is a HTTP request, where the first resource is one of a first website resource or a first webpage resource that is accessible via the at least one cloud-based resource provider, and where the second resource is one of a second website resource or a second webpage resource that is accessible via the at least one first local resource provider. In some instances, the second website resource is a local copy of the first website resource and the second webpage resource is a local copy of the first webpage resource. In some examples, the first resource and the second resource each includes at least one of a compute resource, a storage resource, a VM, a software application, a storage account, a webpage, a website, or a file, wherein the file includes one of a text document, a multimedia document, an image file, an audio file, a video file, or a data file.

In some examples, the first operations further include, further based on a determination that the first local control plane platform has lost the network connection to the cloud-based control plane platform, extracting, by the first authentication proxy, the first ID from the request; authenticating, by the first authentication proxy, the requesting user by verifying whether the first ID provides access to the first resource from the cloud-based control plane platform, wherein the mapping and impersonating processes are performed after a determination that the first ID is verified; and in response to a determination that the first ID is not verified or in response to a determination that there is no mapping between the first ID and the second ID, generating and sending, by the first authentication proxy, a message indicating that the request has failed.

In examples, the first operations further include verifying, by the first authentication proxy, whether the second ID provides access to the second resource from the at least one first local resource provider, wherein the mapping and impersonating processes are performed after a determination that the second ID is verified. In some cases, the first operations further include, in response to a determination that the second ID is not verified to provide access to the second resource from the at least one first local resource provider, generating and sending, by the first authentication proxy, a message indicating that the request has failed.

In some examples, the cloud-based control plane platform further includes a cloud-based resource manager of a cloud-based control plane; and a connectivity platform of the management platform. The first operations further include, based on a determination that the first local control plane platform is currently connected or has re-established connection to the cloud-based control plane platform via the network connection, sending, by the first local resource manager, the request to the cloud-based resource manager; receiving, by the first local resource manager, the first resource from the at least one cloud-based resource provider; and sending, by the first local resource manager, the first resource to the requesting device. In some cases, determining that the first local control plane platform is currently connected or has re-established connection to the cloud-based control plane platform via the network connection is performed based on a communication exchange between the first connectivity agent and the connectivity platform over the network connection.

In examples, the first operations further include, when the first local control plane platform is connected to the cloud-based control plane platform via the network connection, determining, by the first resource synchronization agent, whether the at least one first local resource provider contains at least one first local resource that is not contained in the at least one cloud-based resource provider. The first operations further include, based on a determination that the at least one first local resource provider contains a first local resource that is not contained in the at least one cloud-based resource provider, projecting, by the first resource synchronization agent, the first local resource onto the at least one cloud-based resource provider; and causing the cloud-based resource manager to update a cloud-based resource graph with information regarding the first local resource being projected onto the at least one cloud-based resource provider.

In some examples, the first local control plane platform is one among a plurality of local control plane platforms to which the requesting user has access, wherein the system further includes a second local control plane platform among the plurality of local control plane platforms, the second local control plane platform being separate from both the cloud-based control plane platform and the first local control plane platform. The second local control plane platform includes a second local resource manager of a second local control plane; and at least one second local resource provider. In some cases, the first operations further include, further based on a determination that the first local control plane platform has lost the network connection to the cloud-based control plane platform, determining, by the first local resource manager, whether the at least one first local resource provider contains the second resource corresponding to the first resource. In some instances, the mapping, impersonating, receiving, and sending processes are performed after a determination that the at least one first local resource provider contains the second resource. The first operations further include, in response to a determination that the at least one first local resource provider does not contain the second resource, and based on a determination that the first local control plane platform is currently connected to the second local control plane platform via a second network connection, sending, by the first local resource manager, the request to the second local resource manager of the second local control plane platform; receiving, by the first local resource manager, a third resource from the at least one second local resource provider via the second local resource manager, the third resource corresponding to the first resource; and sending, by the first local resource manager, the third resource to the requesting device.

In examples, the second local control plane platform executes computer executable instructions that cause the second local control plane platform to perform second operations including receiving, by the second local resource manager, the request from the first local resource manager; and determining, by the second local resource manager, whether the at least one second local resource provider contains the third resource corresponding to the first resource. The second operations further include, based on a determination that the at least one second local resource provider contains the third resource corresponding to the first resource, mapping, by a second authentication proxy of the second local resource manager, the first ID to a third ID that is associated with both the requesting user and the second local control plane platform; impersonating, by the second authentication proxy, the requesting user, by: generating a second query for the third resource based on the third ID; and sending the second query to the at least one second local resource provider. The second operations, further based on a determination that the at least one second local resource provider contains the third resource corresponding to the first resource, further includes receiving, by the second local resource manager, the third resource from the at least one second local resource provider; and sending, by the second local resource manager, the third resource to the first local resource manager of the first local control plane platform.

In some examples, each of the first ID and the second ID is a GUID having an ID format that indicates which computing platform that ID is associated with and that indicates at least one of information indicating a subscription type, information indicating a category of that computing platform, information indicating a type of resource providers to which that ID has access within that computing platform, or additional information regarding that computing platform.

In another aspect, the technology relates to a computer-implemented method, including receiving, by a first local control plane platform and from a requesting device, a request to access a first resource stored in a cloud-based control plane platform, the request including a first ID that is associated with both a requesting user and the cloud-based control plane platform; and determining, using a first connectivity agent of the first local control plane platform, whether the first local control plane platform is currently connected to the cloud-based control plane platform. The method further includes, based on a determination that the first local control plane platform has lost network connection to the cloud-based control plane platform, mapping, by a first authentication proxy of a first local resource manager of the first local control plane platform, the first ID to a second ID that is associated with both the requesting user and the first local control plane platform; and impersonating, by the first authentication proxy, the requesting user, by: generating a first query for the first resource based on the second ID; and sending the first query to at least one first local resource provider of the first local control plane platform. The method further includes, further based on a determination that the first local control plane platform has lost network connection to the cloud-based control plane platform, receiving, by the first local resource manager, a second resource from the at least one first local resource provider; and sending, by the first local resource manager, the second resource to the requesting device. The second resource corresponds to the first resource after resource synchronization, using a first resource synchronization agent of the first local control plane platform, between the at least one first local resource provider and at least one cloud-based resource provider of the cloud-based computing system when the first local control plane platform was previously connected to the cloud-based control plane platform via the network connection.

The method further includes, further based on a determination that the first local control plane platform has lost the network connection to the cloud-based control plane platform, extracting, by the first authentication proxy, the first ID from the request; authenticating, by the first authentication proxy, the requesting user by verifying whether the first ID provides access to the first resource from the cloud-based control plane platform, wherein the mapping and impersonating processes are performed after a determination that the first ID is verified; and in response to a determination that the first ID is not verified, generating and sending, by the first authentication proxy, a message indicating that the request has failed.

In some examples, the method further includes verifying, by the first authentication proxy, whether the second ID provides access to the second resource from the at least one first local resource provider, wherein the mapping and impersonating processes are performed after a determination that the first ID is verified; and in response to a determination that the second ID is not verified to provide access to the second resource from the at least one first local resource provider, generating and sending, by the first authentication proxy, a message indicating that the request has failed.

In examples, the method further includes, based on a determination that the first local control plane platform is currently connected or has re-established connection to the cloud-based control plane platform via the network connection, sending, by the first local resource manager, the request to a cloud-based resource manager of a cloud-based control plane of the cloud-based control plane platform; receiving, by the first local resource manager, the first resource from the at least one cloud-based resource provider; and sending, by the first local resource manager, the first resource to the requesting device. In some cases, determining that the first local control plane platform is currently connected or has re-established connection to the cloud-based control plane platform via the network connection is performed based on a communication exchange between the first connectivity agent and a connectivity platform of a management platform of the cloud-based control plane platform over the network connection.

In some examples, the method further includes, when the first local control plane platform is connected to the cloud-based control plane platform via the network connection, determining, by the first resource synchronization agent, whether the at least one first local resource provider contains at least one first local resource that is not contained in the at least one cloud-based resource provider. The method further includes, based on a determination that the at least one first local resource provider contains a first local resource that is not contained in the at least one cloud-based resource provider, projecting, by the first resource synchronization agent, the first local resource onto the at least one cloud-based resource provider; and causing a cloud-based resource manager of a cloud-based control plane of the cloud-based control plane platform to update a cloud-based resource graph with information regarding the first local resource being projected onto the at least one cloud-based resource provider.

In yet another aspect, the technology relates to a system, including a cloud-based control plane platform; a first local control plane platform; and a second local control plane platform. The first local control plane platform includes a first local resource manager of a first local control plane; a first connectivity agent of a management platform; and at least one first local resource provider. The second local control plane platform includes a second local resource manager of a second local control plane; and at least one second local resource provider. The first local control plane platform executes computer executable instructions that cause the first local control plane platform to perform operations including receiving, from a requesting device, a request to access a first resource stored in the cloud-based control plane platform, the request including a first ID that is associated with both a requesting user and the cloud-based control plane platform; and determining, using the first connectivity agent, whether the first local control plane platform is currently connected to the cloud-based control plane platform. The operations further include, based on a determination that the first local control plane platform has lost the network connection to the cloud-based control plane platform, determining, by the first local resource manager, whether the at least one first local resource provider contains a second resource corresponding to the first resource. In an example, based on a determination that the at least one first local resource provider contains the second resource, the operations further include mapping, by a first authentication proxy of the first local resource manager of the first local control plane platform, the first ID to a second ID that is associated with both the requesting user and the first local control plane platform; impersonating, by the first authentication proxy, the requesting user, by generating a first query for the first resource based on the second ID, and sending the first query to the at least one first local resource provider; receiving, by the first local resource manager, the second resource from the at least one first local resource provider; and sending, by the first local resource manager, the second resource to the requesting device. Alternatively, based a determination that the at least one first local resource provider does not contain the second resource, and based on a determination that the first local control plane platform is currently connected to the second local control plane platform via a second network connection, the operations further include sending, by the first local resource manager, the request to the second local resource manager of the second local control plane platform; receiving, by the first local resource manager, a third resource from the at least one second local resource provider via the second local resource manager, the third resource corresponding to the first resource; and sending, by the first local resource manager, the third resource to the requesting device.

In some examples, the second local control plane platform executes computer executable instructions that cause the second local control plane platform to perform second operations including receiving, by the second local resource manager, the request from the first local resource manager; determining, by the second local resource manager, whether the at least one second local resource provider contains the third resource corresponding to the first resource. The second operations further include, based on a determination that the at least one second local resource provider contains the third resource corresponding to the first resource, mapping, by a second authentication proxy of the second local resource manager, the first ID to a third ID that is associated with both the requesting user and the second local control plane platform; impersonating, by the second authentication proxy, the requesting user, by generating a second query for the third resource based on the third ID, and sending the second query to the at least one second local resource provider. The second operations further include receiving, by the second local resource manager, the third resource from the at least one second local resource provider; and sending, by the second local resource manager, the third resource to the first local resource manager of the first local control plane platform.

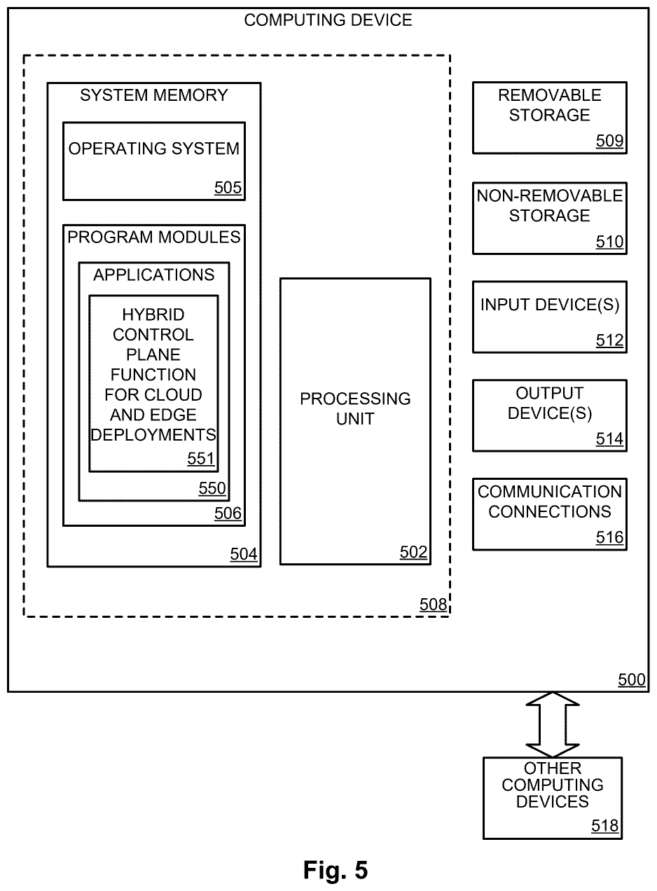

FIG. 5 depicts a block diagram illustrating physical components (i.e., hardware) of a computing device 500 with which examples of the present disclosure may be practiced. The computing device components described below may be suitable for a client device implementing the hybrid control plane for cloud and edge deployments, as discussed above. In a basic configuration, the computing device 500 may include at least one processing unit 502 and a system memory 504. The processing unit(s) (e.g., processors) may be referred to as a processing system. Depending on the configuration and type of computing device, the system memory 504 may include volatile storage (e.g., random access memory), non-volatile storage (e.g., read-only memory), flash memory, or any combination of such memories. The system memory 504 may include an operating system 505 and one or more program modules 506 suitable for running software applications 550, such as a hybrid control plane function for cloud and edge deployments 551, to implement one or more of the systems or methods described above.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionalities. For example, the computing device 500 may also include additional data storage devices (which may be removable and/or non-removable), such as, for example, magnetic disks, optical disks, or tape. Such additional storage is illustrated in FIG. 5 by a removable storage device(s) 509 and a non-removable storage device(s) 510.

As stated above, a number of program modules and data files may be stored in the system memory 504. While executing on the processing unit 502, the program modules 506 may perform processes including one or more of the operations of the method(s) as illustrated in FIGS. 3A-4D, or one or more operations of the system(s) and/or apparatus(es) as described with respect to FIGS. 1-2D, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 500 may also have one or more input devices 512 such as a keyboard, a mouse, a pen, a sound input device, and/or a touch input device, etc. The output device(s) 514 such as a display, speakers, and/or a printer, etc. may also be included. The aforementioned devices are examples and others may be used. The computing device 500 may include one or more communication connections 516 allowing communications with other computing devices 518. Examples of suitable communication connections 516 include radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 504, the removable storage device 509, and the non-removable storage device 510 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A system, comprising:
a first local control plane platform, comprising:
a first local resource manager of a first local control plane;
a first connectivity agent of a management platform;
at least one first local resource provider; and
a first resource synchronization agent;
wherein the first local control plane platform executes computer executable instructions that cause the first local control plane platform to perform first operations comprising:
receiving, from a requesting device, a request to access a first resource stored in a cloud-based control plane platform, the request including a first identifier (“ID”) that is associated with both a requesting user and the cloud-based control plane platform;
determining, using the first connectivity agent, whether the first local control plane platform is currently connected to the cloud-based control plane platform; and
based on a determination that the first local control plane platform has lost network connection to the cloud-based control plane platform,
mapping, by a first authentication proxy of the first local resource manager, the first ID to a second ID that is associated with both the requesting user and the first local control plane platform;
impersonating, by the first authentication proxy, the requesting user, by:
generating a first query for the first resource based on the second ID; and
sending the first query to the at least one first local resource provider;
receiving, by the first local resource manager, a second resource from the at least one first local resource provider, the second resource corresponding to the first resource after resource synchronization, using the first resource synchronization agent, between the at least one first local resource provider and at least one cloud-based resource provider of the cloud-based computing system when the first local control plane platform was previously connected to the cloud-based control plane platform via the network connection; and
sending, by the first local resource manager, the second resource to the requesting device.

2. The system of claim 1, wherein the cloud-based control plane platform is implemented within a server in a service provider data center that is associated with a service provider, wherein the first local control plane platform is implemented within a first local computing system at a first premises location.

3. The system of claim 2, wherein the first local computing system is sent to the first premises location by the service provider, and wherein the first local control plane platform is implemented in a virtual machine (“VM”) that is instantiated in the first local computing system.

4. The system of claim 1, wherein the request is a hypertext transfer protocol (“HTTP”) request, wherein the first resource is one of a first website resource or a first webpage resource that is accessible via the at least one cloud-based resource provider, wherein the second resource is one of a second website resource or a second webpage resource that is accessible via the at least one first local resource provider, wherein the second website resource is a local copy of the first website resource and the second webpage resource is a local copy of the first webpage resource.

5. The system of claim 1, wherein the first resource and the second resource each includes at least one of a compute resource, a storage resource, a VM, a software application, a storage account, a webpage, a website, or a file, wherein the file includes one of a text document, a multimedia document, an image file, an audio file, a video file, or a data file.

6. The system of claim 1, wherein the first operations further comprise:
further based on a determination that the first local control plane platform has lost the network connection to the cloud-based control plane platform,
extracting, by the first authentication proxy, the first ID from the request;
authenticating, by the first authentication proxy, the requesting user by verifying whether the first ID provides access to the first resource from the cloud-based control plane platform, wherein the mapping and impersonating processes are performed after a determination that the first ID is verified; and
in response to a determination that the first ID is not verified or in response to a determination that there is no mapping between the first ID and the second ID, generating and sending, by the first authentication proxy, a message indicating that the request has failed.

7. The system of claim 1, wherein the first operations further comprise:
verifying, by the first authentication proxy, whether the second ID provides access to the second resource from the at least one first local resource provider, wherein the mapping and impersonating processes are performed after a determination that the second ID is verified; and
in response to a determination that the second ID is not verified to provide access to the second resource from the at least one first local resource provider, generating and sending, by the first authentication proxy, a message indicating that the request has failed.

8. The system of claim 1,
wherein the cloud-based control plane platform further comprises:
a cloud-based resource manager of a cloud-based control plane; and
a connectivity platform of the management platform;
wherein the first operations further comprise:
based on a determination that the first local control plane platform is currently connected or has re-established connection to the cloud-based control plane platform via the network connection,
sending, by the first local resource manager, the request to the cloud-based resource manager;
receiving, by the first local resource manager, the first resource from the at least one cloud-based resource provider; and
sending, by the first local resource manager, the first resource to the requesting device;
wherein determining that the first local control plane platform is currently connected or has re-established connection to the cloud-based control plane platform via the network connection is performed based on a communication exchange between the first connectivity agent and the connectivity platform over the network connection.

9. The system of claim 8, wherein the first operations further comprise:
when the first local control plane platform is connected to the cloud-based control plane platform via the network connection, determining, by the first resource synchronization agent, whether the at least one first local resource provider contains at least one first local resource that is not contained in the at least one cloud-based resource provider;
based on a determination that the at least one first local resource provider contains a first local resource that is not contained in the at least one cloud-based resource provider,
projecting, by the first resource synchronization agent, the first local resource onto the at least one cloud-based resource provider; and
causing the cloud-based resource manager to update a cloud-based resource graph with information regarding the first local resource being projected onto the at least one cloud-based resource provider.

10. The system of claim 1, wherein the first local control plane platform is one among a plurality of local control plane platforms to which the requesting user has access, wherein the system further comprises:
a second local control plane platform among the plurality of local control plane platforms, the second local control plane platform being separate from both the cloud-based control plane platform and the first local control plane platform, the second local control plane platform comprising:
a second local resource manager of a second local control plane; and
at least one second local resource provider;
wherein the first operations further comprise:
further based on a determination that the first local control plane platform has lost the network connection to the cloud-based control plane platform,
determining, by the first local resource manager, whether the at least one first local resource provider contains the second resource corresponding to the first resource, wherein the mapping, impersonating, receiving, and sending processes are performed after a determination that the at least one first local resource provider contains the second resource;
in response to a determination that the at least one first local resource provider does not contain the second resource, and based on a determination that the first local control plane platform is currently connected to the second local control plane platform via a second network connection,
sending, by the first local resource manager, the request to the second local resource manager of the second local control plane platform;
receiving, by the first local resource manager, a third resource from the at least one second local resource provider via the second local resource manager, the third resource corresponding to the first resource; and
sending, by the first local resource manager, the third resource to the requesting device.

11. The system of claim 10,
wherein the second local control plane platform executes computer executable instructions that cause the second local control plane platform to perform second operations comprising:
receiving, by the second local resource manager, the request from the first local resource manager;
determining, by the second local resource manager, whether the at least one second local resource provider contains the third resource corresponding to the first resource;
based on a determination that the at least one second local resource provider contains the third resource corresponding to the first resource,
mapping, by a second authentication proxy of the second local resource manager, the first ID to a third ID that is associated with both the requesting user and the second local control plane platform;
impersonating, by the second authentication proxy, the requesting user, by:
generating a second query for the third resource based on the third ID; and
sending the second query to the at least one second local resource provider;
receiving, by the second local resource manager, the third resource from the at least one second local resource provider; and
sending, by the second local resource manager, the third resource to the first local resource manager of the first local control plane platform.

12. The system of claim 1, wherein each of the first ID and the second ID is a globally unique ID (“GUID”) having an ID format that indicates which computing platform that ID is associated with and that indicates at least one of information indicating a subscription type, information indicating a category of that computing platform, information indicating a type of resource providers to which that ID has access within that computing platform, or additional information regarding that computing platform.

13. A computer-implemented method, comprising:
receiving, by a first local control plane platform and from a requesting device, a request to access a first resource stored in a cloud-based control plane platform, the request including a first identifier (“ID”) that is associated with both a requesting user and the cloud-based control plane platform;
determining, using a first connectivity agent of the first local control plane platform, whether the first local control plane platform is currently connected to the cloud-based control plane platform;
based on a determination that the first local control plane platform has lost network connection to the cloud-based control plane platform,
mapping, by a first authentication proxy of a first local resource manager of the first local control plane platform, the first ID to a second ID that is associated with both the requesting user and the first local control plane platform;
impersonating, by the first authentication proxy, the requesting user, by:
generating a first query for the first resource based on the second ID; and
sending the first query to at least one first local resource provider of the first local control plane platform;
receiving, by the first local resource manager, a second resource from the at least one first local resource provider, the second resource corresponding to the first resource after resource synchronization, using a first resource synchronization agent of the first local control plane platform, between the at least one first local resource provider and at least one cloud-based resource provider of the cloud-based computing system when the first local control plane platform was previously connected to the cloud-based control plane platform via the network connection; and
sending, by the first local resource manager, the second resource to the requesting device.

14. The computer-implemented method of claim 13, further comprising:
further based on a determination that the first local control plane platform has lost the network connection to the cloud-based control plane platform,
extracting, by the first authentication proxy, the first ID from the request;
authenticating, by the first authentication proxy, the requesting user by verifying whether the first ID provides access to the first resource from the cloud-based control plane platform, wherein the mapping and impersonating processes are performed after a determination that the first ID is verified; and
in response to a determination that the first ID is not verified, generating and sending, by the first authentication proxy, a message indicating that the request has failed.

15. The computer-implemented method of claim 13, further comprising:
verifying, by the first authentication proxy, whether the second ID provides access to the second resource from the at least one first local resource provider, wherein the mapping and impersonating processes are performed after a determination that the first ID is verified; and
in response to a determination that the second ID is not verified to provide access to the second resource from the at least one first local resource provider, generating and sending, by the first authentication proxy, a message indicating that the request has failed.

16. The computer-implemented method of claim 13, further comprising:
based on a determination that the first local control plane platform is currently connected or has re-established connection to the cloud-based control plane platform via the network connection,
sending, by the first local resource manager, the request to a cloud-based resource manager of a cloud-based control plane of the cloud-based control plane platform;
receiving, by the first local resource manager, the first resource from the at least one cloud-based resource provider; and
sending, by the first local resource manager, the first resource to the requesting device.

17. The computer-implemented method of claim 16, wherein determining that the first local control plane platform is currently connected or has re-established connection to the cloud-based control plane platform via the network connection is performed based on a communication exchange between the first connectivity agent and a connectivity platform of a management platform of the cloud-based control plane platform over the network connection.

18. The computer-implemented method of claim 13, further comprising:
when the first local control plane platform is connected to the cloud-based control plane platform via the network connection, determining, by the first resource synchronization agent, whether the at least one first local resource provider contains at least one first local resource that is not contained in the at least one cloud-based resource provider;
based on a determination that the at least one first local resource provider contains a first local resource that is not contained in the at least one cloud-based resource provider,
projecting, by the first resource synchronization agent, the first local resource onto the at least one cloud-based resource provider; and
causing a cloud-based resource manager of a cloud-based control plane of the cloud-based control plane platform to update a cloud-based resource graph with information regarding the first local resource being projected onto the at least one cloud-based resource provider.

19. A system, comprising:
a cloud-based control plane platform;
a first local control plane platform, comprising:
a first local resource manager of a first local control plane;
a first connectivity agent of a management platform; and
at least one first local resource provider; and
a second local control plane platform, comprising:
a second local resource manager of a second local control plane; and
at least one second local resource provider;
wherein the first local control plane platform executes computer executable instructions that cause the first local control plane platform to perform operations comprising:
receiving, from a requesting device, a request to access a first resource stored in the cloud-based control plane platform, the request including a first identifier (“ID”) that is associated with both a requesting user and the cloud-based control plane platform;
determining, using the first connectivity agent, whether the first local control plane platform is currently connected to the cloud-based control plane platform; and
based on a determination that the first local control plane platform has lost the network connection to the cloud-based control plane platform,
determining, by the first local resource manager, whether the at least one first local resource provider contains a second resource corresponding to the first resource;
performing one of:
based on a determination that the at least one first local resource provider contains the second resource,
mapping, by a first authentication proxy of the first local resource manager of the first local control plane platform, the first ID to a second ID that is associated with both the requesting user and the first local control plane platform;
impersonating, by the first authentication proxy, the requesting user, by:
generating a first query for the first resource based on the second ID; and
sending the first query to the at least one first local resource provider;
receiving, by the first local resource manager, the second resource from the at least one first local resource provider; and
sending, by the first local resource manager, the second resource to the requesting device; or
based a determination that the at least one first local resource provider does not contain the second resource, and based on a determination that the first local control plane platform is currently connected to the second local control plane platform via a second network connection,
sending, by the first local resource manager, the request to the second local resource manager of the second local control plane platform;
receiving, by the first local resource manager, a third resource from the at least one second local resource provider via the second local resource manager, the third resource corresponding to the first resource; and
sending, by the first local resource manager, the third resource to the requesting device.

20. The system of claim 19,
wherein the second local control plane platform executes computer executable instructions that cause the second local control plane platform to perform second operations comprising:
receiving, by the second local resource manager, the request from the first local resource manager;
determining, by the second local resource manager, whether the at least one second local resource provider contains the third resource corresponding to the first resource;
based on a determination that the at least one second local resource provider contains the third resource corresponding to the first resource,
mapping, by a second authentication proxy of the second local resource manager, the first ID to a third ID that is associated with both the requesting user and the second local control plane platform;
impersonating, by the second authentication proxy, the requesting user, by:
generating a second query for the third resource based on the third ID; and
sending the second query to the at least one second local resource provider;
receiving, by the second local resource manager, the third resource from the at least one second local resource provider; and
sending, by the second local resource manager, the third resource to the first local resource manager of the first local control plane platform.
